(19) United States
(12) Patent Application Publication
(10) Pub. No.: US 2009/0098512 A1
(43) Pub. Date: Apr. 16, 2009

(54) METHOD FOR ARRANGING A BRIDGE IN A SET OF TEETH AND A BRIDGE FOR APPLICATION IN THAT METHOD

(76) Inventors: Willem Boer, Hoogeveen (NL); Maarten Willem Boer, Amsterdam (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/281,766

(22) PCT Filed: Mar. 8, 2007
(86) PCT No.: PCT/NL07/00063

§ 371 Date: Dec. 5, 2008

(30) Foreign Application Priority Data
Mar. 8, 2006 (NL) NL1031325

(51) Int. Cl. A61C 5/11; A61C 8/00

(52) U.S. Cl. 433/219; 433/223

(57) ABSTRACT

Method for arranging a bridge (16) in a set of teeth. The bridge (16) comprises at least two crowns (17,18) placed fixedly therein. The bridge (16) is provided with cavities for receiving therein in at least practically fitting manner at least two mounting bases (14,15) which extend from a jaw. The bridge (16) is arranged with the cavities over the at least two mounting bases (14,15). The bridge (16) is fixed onto the at least two mounting bases (14,15). Both a translating movement and a rotating movement are performed with the bridge (16) during placing thereof over the at least two mounting bases (14,15).

The invention relates to a method for arranging a bridge in a set of teeth, wherein the bridge comprises at least two crowns placed fixedly therein, wherein the bridge is provided with cavities for receiving therein in at least practically fitting manner at least two mounting bases which extend from a jaw, wherein the bridge is arranged with the cavities over the at least two mounting bases and wherein the bridge is fixed onto the at least two mounting bases. The invention further relates to a bridge for application in this method.

The invention also relates to a device for simulating the provision of mounting bases in a jaw.

The invention further relates to a device for manufacturing a bridge for a set of teeth.

It is known to prepare or to grind two elements of a set of teeth to stumps with tapering side walls for the purpose of arranging a bridge thereover, this bridge being provided with two crowns fixedly placed therein, i.e. a bridge which is formed integrally. After the stumps have been made, the bridge is made such that respective cavities in the crowns of the bridge can be arranged fitting over the stumps. The bridge is then arranged with the cavities over the stumps and the bridge is fixed relative to the stumps.

The known method finds application in those situations in which the elements for preparing are parallel or only slightly crooked relative to each other. The elements can then be prepared in order to form stumps over which the crowns of the bridge can be pushed in the same direction. The stumps then have the same or a shared insertion direction. A dentist will in practice check whether there is a shared insertion direction by looking at the stumps from above from one point using one eye. There is a shared insertion direction when the whole surface of the side walls of both stumps is visible. A bridge can then be arranged over the stumps. Alternatively, a dentist can check whether there is a shared insertion direction using a striped mirror.

When elements are more crooked relative to each other, the known method has the drawback that a relatively large amount of material must be ground off the elements to prepare them in order to form stumps with a shared insertion direction. These elements are hereby weakened, and there is then the further danger of also making contact with the pulp during grinding. The side walls of the stumps are then also often prepared with a greater convergence, which is disadvantageous for a firm adhesion of the bridge to the stumps.

When elements are even more crooked relative to each other, preparation thereof to form stumps with a shared insertion direction is even practically impossible. If such elements were to be prepared, stumps would result without a shared insertion direction. The stumps are then undercut and not the whole surface of the side walls of the two stumps is then visible as seen from one point from above with one eye. The professional literature teaches that a bridge with crowns fixedly placed therein cannot be arranged over undercuts stumps. This is because at a certain moment the one crown of the bridge will have to move in opposite direction relative to the other crown of the bridge so as to reach the foot of the relevant stump.

Various alternative methods are known for nevertheless being able to place a bridge in the case of crooked elements which would result in undercut stumps after preparation.

In a first method the elements are mutually straightened using orthodontics so that the elements can then be prepared in order to form stumps with a shared insertion direction. This is however very expensive. The use of braces can furthermore meet with objections from the patient, for instance from an aesthetic viewpoint. Mutual straightening of the elements is further relatively time-consuming, while a rapid placing of the bridge may be desired, for instance after the sudden loss of a molar or tooth.

In a second method a bridge assembled from two crown parts is used. One of the crown parts is for instance connected fixedly to a dummy element. The one crown part, which is provided with a protrusion, is first arranged over its stump. The other crown part, which is fixedly connected to the dummy element, is then pushed over its stump, wherein a groove arranged in the dummy element slides close-fittingly over the protrusion of the one crown part so as to realize the assembled bridge connection. This method has the drawback that the parts sliding over each other must be made with great precision. This method is therefore expensive. The assembly of a bridge from two separate crown parts moreover results in limitations in respect of strength.

In a third method one of the stumps undergoes a root canal treatment. A superstructure is then arranged crookedly on top of this stump such that the superstructure and the other stump have a shared insertion direction. This method has the drawback that it is expensive and that the element undergoing the root canal treatment is greatly weakened.

It is an object of the invention to provide a method which makes it possible to arrange the bridge, which is provided with at least two crowns placed fixedly therein, over mounting bases which are undercut in a direction transversely of a row of teeth or molars.

In order to achieve the intended object the method of the type stated in the preamble has the feature that both a translating movement and a rotating movement are performed with the bridge during placing thereof over the at least two mounting bases. By not only translating but also rotating the bridge, it becomes possible to slide the respective crowns thereof over the undercut mounting bases. This is because the rotating movement makes the one crown of the bridge move in a different direction relative to the other crown of the bridge. It is thus made possible for each crown to reach the foot of the relevant undercut mounting base. It is no longer necessary to provide a great measure of chamfering of the side walls of relatively crooked mounting bases in order to obtain a shared insertion direction. A better adhesion of the bridge on the mounting bases is hereby obtained. Because the crowns are placed fixedly in the bridge, this bridge has a relatively great strength. When the mounting bases are in extremely crooked position relative to each other in a direction transversely of the row of teeth or molars, it is also possible with the method according to the invention to arrange a bridge thereon.

In an embodiment a prepared element is applied for at least one of the at least two mounting bases. When the elements are more crooked relative to each other in a direction transversely of the row of teeth or molars, it is no longer necessary to grind a large amount of material therefrom in order to obtain mounting bases with mutually compatible insertion directions. Only a minimal amount of material has to be ground away instead so as to obtain mounting bases which may now be undercut in order to arrange a bridge thereover. The elements thus retain their strength optimally.

In an alternative embodiment a superstructure on an implant arranged in the jaw is applied for at least one of the at least two mounting bases.

In a preferred embodiment the translating movement and rotating movement are performed simultaneously, for instance by arranging the bridge over the at least two mounting bases by means of a helical movement, so as to place the bridge in rapid and simple manner. In one aspect of the invention the cavities are formed in the bridge such that they leave space for the translating and the rotating movement of the bridge over the at least two mounting bases. In one embodiment stump-like mounting bases are used.

The invention further provides a bridge for a set of teeth, wherein the bridge comprises at least two crowns placed fixedly therein and wherein the bridge is provided with cavities for receiving therein in at least practically fitting manner mounting bases which extend from a jaw, characterized in that at least two of the cavities are undercut in a direction transversely of a longitudinal direction of the bridge. Such a bridge is recognisable in that not the whole surface of the side walls of the cavities in the bridge is then visible as seen from one point using one eye, analogous that described above for undercut stumps. Such a bridge is suitable for arranging over buccolingual undercut mounting bases with the method according to the invention.

In an embodiment at least one dummy element is provided between two adjacent crowns.

The invention further provides a device for simulating the provision of mounting bases in a jaw, wherein the device is able to simulate at least two of the mounting bases as mounting bases which are undercut in a direction transversely of a row formed by the mounting bases, and wherein the device comprises a control code for controlling the device, characterized in that the control code enables the device to indicate that a bridge with at least two crowns placed fixedly therein can be arranged over the undercut mounting bases. Known numerically controlled devices for simulating the provision of mounting bases in a jaw do have the possibility of simulating undercut mounting bases in the jaw, but these devices have heretofore not taken into account the possibility of placing a bridge on two or more buccolingual undercut mounting bases, or indicate that it is precisely in this situation that placing of a bridge is impossible. It was after all the opinion heretofore that an integrally formed bridge could not be arranged over undercut mounting bases. The device for the simulation according to the invention does however allow simulation of the arranging of a bridge over undercut mounting bases. The device for simulation finds application for instance in determining optimal positions in the jaw for arranging implants, wherein the implants serve for arranging of respective mounting bases thereon. The device for the simulation according to the invention has the possibility of indicating when a bridge can be placed, taking into account the possibility that under certain conditions the mounting bases may herein be undercut in buccolingual direction.

A preferred embodiment of the device for the simulation according to the invention has the feature that the control code enables the device to simulate an arranging of the bridge over the undercut mounting bases and to show the simulation of the arranging of the bridge over the undercut mounting bases using display means of the device. The arranging of the bridge by means of both a translating movement and a rotating movement can thus be displayed to a user of the device.

A further preferred embodiment of the device for the simulation according to the invention has the feature that the device is able to simulate the at least two mounting bases as truncated cones, wherein one truncated cone has an imaginary top angle α and wherein another truncated cone has an imaginary top angle β, and wherein respective axes of the truncated cones enclose an angle γ, wherein: γ>(α+β)/2. When the angles α, β and γ satisfy this relation, the mounting bases are undercut and the invention finds application.

A preferred embodiment of the device for the simulation according to the invention has the feature that the device is provided with input means for receiving one or more data from a group comprising a geometry of the jaw, a degree of chamfering of side walls of the mounting bases, a relatively crooked position of the mounting bases, locations at which the mounting bases are provided in the jaw. The geometry of the jaw for instance relates to dimensions and shape of the jaw, and these data can be obtained by a scan of the jaw. The possibility of varying the degree of chamfering of side walls of the mounting bases with the input means enables the user of the device to determine an optimal chamfering of the side walls, for instance with a view to the best possible retention of the bridge on the mounting bases. The possibility of varying the locations at which mounting bases are provided using the input means enables the user of the device to determine the optimal location of the mounting bases in the jaw.

The invention also provides a device for manufacturing a bridge for a set of teeth, wherein the bridge comprises at least two crowns placed fixedly therein, wherein the device comprises means for arranging cavities in the bridge for receiving in the cavities in at least practically fitting manner mounting bases provided in a jaw, and wherein the device comprises a control code for controlling the device, characterized in that the control code enables the means for arranging cavities in the bridge to arrange at least two of the cavities as cavities which are undercut in a direction transversely of a longitudinal direction of the bridge. A bridge manufactured with such a device and provided with the undercut cavities can be arranged over undercut stumps using the method according to the invention.

A preferred embodiment of the device for manufacturing a bridge according to the invention herein has the feature that the device is provided with input means for receiving one or more data from a group comprising a shape of a bridge to be manufactured, dimensions of a bridge to be manufactured, a shape of cavities to be arranged, dimensions of cavities to be arranged.

A further preferred embodiment of the device for manufacturing a bridge according to the invention herein has the feature that the means for arranging cavities in the bridge comprise a cutter.

The invention will now be further elucidated on the basis of an exemplary embodiment and associated figures. The figures are schematic and not (always) drawn to scale. Some dimensions in particular may be exaggerated to a greater or lesser extent for the sake of clarity. Corresponding parts are designated as far as possible in the figures with the same reference numeral.

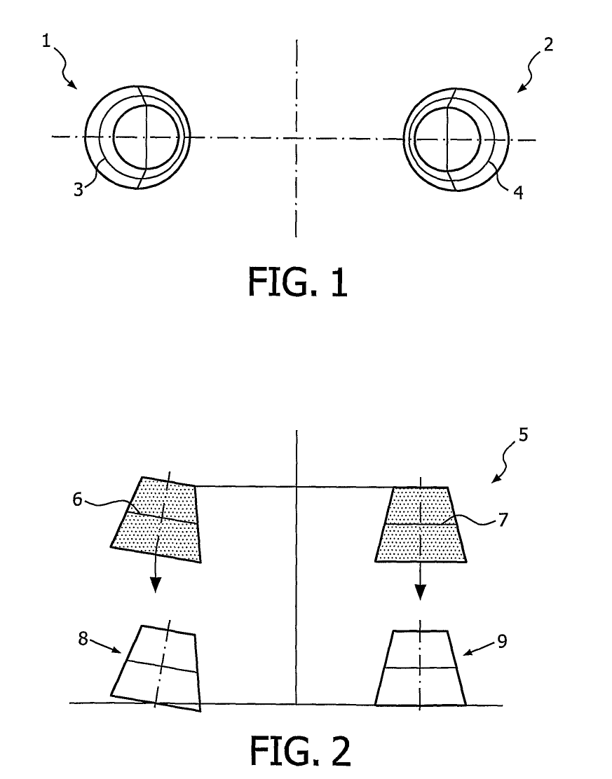

FIG. 1 shows an exemplary embodiment of two stumps with a shared insertion direction.

FIG. 2 shows an exemplary embodiment of the known method for arranging a bridge.

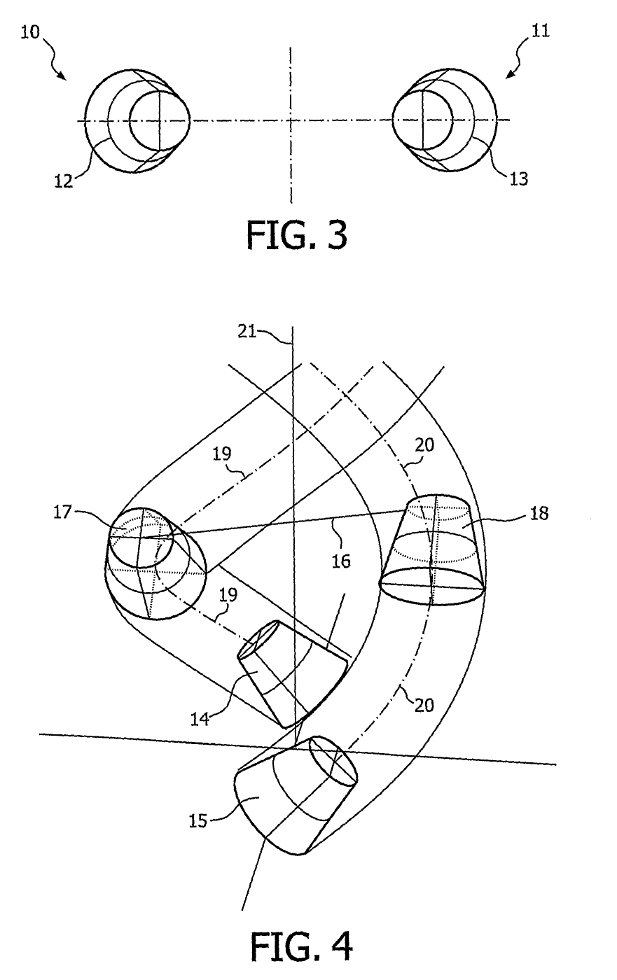

FIG. 3 shows a first exemplary embodiment of undercut stumps.

FIG. 4 shows schematically a first exemplary embodiment of the method according to the invention for arranging a bridge.

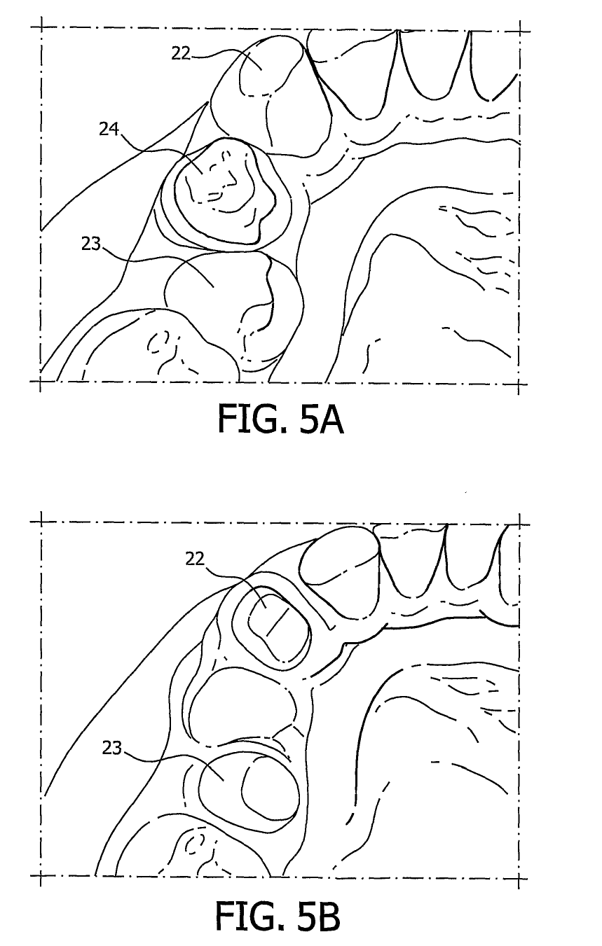

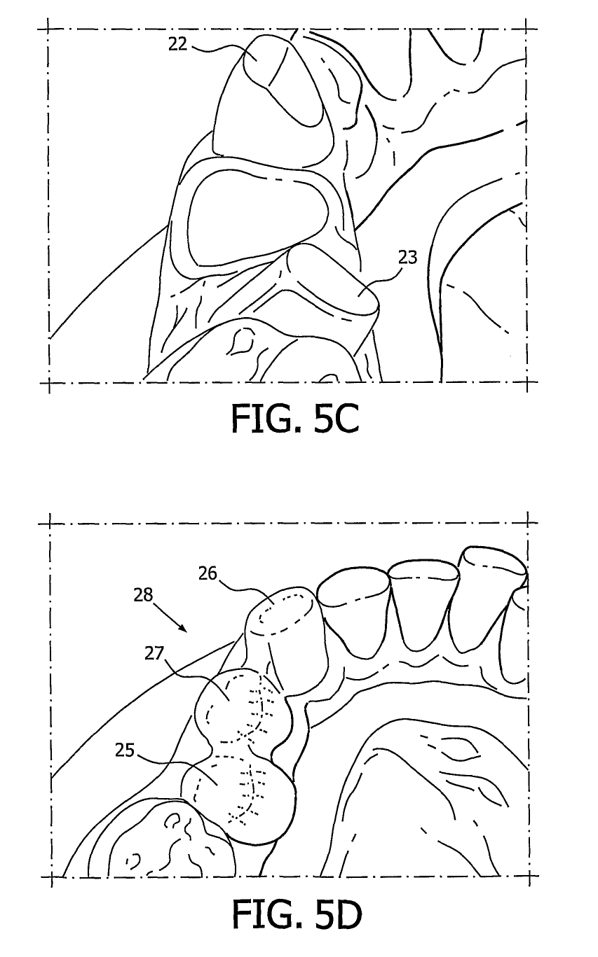

FIGS. 5A-D show a second exemplary embodiment of the method according to the invention for arranging a bridge.

The stumps 1,2 with respective side walls 3,4 shown in FIG. 1 have the form of a truncated cone. Such a form can for instance be applied in the case that the stump is a superstructure on an implant in a jaw. Stumps of prepared elements will in practice have a form which differs to a greater or lesser extent from the form shown in FIG. 1.

Stumps 1,2 have a shared insertion direction: crowns of a bridge can be pushed in the same direction over stumps 1,2 in known manner. The whole surface of side walls 3,4 can be seen from one point using one eye.

FIG. 2 shows the arranging in the known manner of a schematically shown bridge 5 with crowns 6,7 over stumps 8,9 along a shared insertion direction indicated with arrows.

Stumps 10,11 with side walls 12,13 shown in FIG. 3 are undercut as a result of the relatively crooked position of stumps 10,11 in a direction of the row of teeth or molars. There is no shared insertion direction for stumps 10,11: a bridge cannot be arranged thereover.

The stumps (mounting bases) 14,15 of FIG. 4 extending from a jaw are undercut as a result of the relatively crooked position of stumps 14,15 in a direction transversely of the row of teeth or molars (in a direction transversely of a row formed by the mounting bases). A bridge 16 with crowns 17,18 placed fixedly therein (an integrally formed bridge) is arranged according to the invention by sliding crowns 17,18 with respective cavities provided therein over stumps 14,15 along respective helical paths 19,20. The latter can be achieved by means of a helical movement of bridge 16 about an imaginary rotation axis 21. The helical movement of bridge 16 about rotation axis 21 makes it possible for the two crowns 17,18 to move in mutually different directions to reach the foot of the relevant stump 14,15. Stumps 14,15 are herein received in at least practically fitting manner in the respective cavities of bridge 16.

It is further noted that, when stumps are undercut in a direction of the row of teeth or molars as shown in FIG. 3, the method according to the invention cannot be applied. FIG. 5A shows two elements 22,23 in a set of teeth which are undercut in a direction transversely of the row of teeth/molars. An element 24 is extracted. Elements 22,23 are then prepared in order to form undercut stumps as shown in FIGS. 5B and 5C. A bridge 28 with crowns 25,26 and a dummy element 27 placed fixedly therein (integrally formed bridge) is then arranged over stumps 22,23 as shown in FIG. 5D with a helical movement.

The arranging according to the invention of bridge 28 over undercut stumps 22,23 can take place in rapid, simple and inexpensive manner. It is no longer necessary to apply orthodontics or an assembled bridge, or to grind a large amount of material from elements in order to obtain stumps with a shared insertion direction.

1. Method for arranging a bridge in a set of teeth, wherein the bridge comprises at least two crowns placed fixedly therein, wherein the bridge is provided with cavities for receiving therein in at least practically fitting manner at least two mounting bases which extend from a jaw, wherein the bridge is arranged with the cavities over the at least two mounting bases and wherein the bridge is fixed onto the at least two mounting bases, characterized in that both a translating movement and a rotating movement are performed with the bridge during placing thereof over the at least two mounting bases.

2. Method as claimed in claim 1, characterized in that a prepared element is applied for at least one of the at least two mounting bases.

3. Method as claimed in claim 1, characterized in that a superstructure on an implant arranged in the jaw is applied for at least one of the at least two mounting bases.

4. Method as claims in claim 1, characterized in that the translating movement and the rotating movement are performed simultaneously.

5. Method as claimed in claim 1, characterized in that the bridge is arranged over the at least two mounting bases by means of a helical movement.

6. Method as claimed in claim 1, characterized in that the cavities are formed in the bridge such that they leave space for the translating and rotating movement of the bridge over the at least two mounting bases.

7. Method as claimed in claim 1, characterized in that stump-like mounting bases are used.

8. Bridge for a set of teeth, wherein the bridge comprises at least two crowns placed fixedly therein and wherein the bridge is provided with cavities for receiving therein in at least practically fitting manner mounting bases which extend from a jaw, characterized in that at least two of the cavities are undercut in a direction transversely of a longitudinal direction of the bridge.

9. Bridge as claimed in claim 8, characterized in that at least one dummy element is provided between two adjacent crowns.

10. Device for simulating the provision of mounting bases in a jaw, wherein the device is able to simulate at least two of the mounting bases as mounting bases which are undercut in a direction transversely of a row formed by the mounting bases, and wherein the device comprises a control code for controlling the device, characterized in that the control code enables the device to indicate that a bridge with at least two crowns placed fixedly therein can be arranged over the undercut mounting bases.

11. Device as claimed in claim 10, characterized in that the control code enables the device to simulate an arranging of the bridge over the undercut mounting bases and to show the simulation of the arranging of the bridge over the undercut mounting bases using display means of the device.

12. Device as claimed in claim 10, characterized in that the device is able to simulate the at least two mounting bases as truncated cones, wherein one truncated cone has an imaginary top angle α and wherein another truncated cone has an imaginary top angle β, and wherein respective axes of the truncated cones enclose an angle γ, wherein γ>(α+β)/2.

13. Devices as claimed in claim 10, characterized in that the device is provided with input means for receiving one or more data from a group comprising a geometry of the jaw, a degree of chamfering of side walls of the mounting bases, a relatively crooked position of the mounting bases, locations at which the mounting bases are provided in the jaw.

14. Device for manufacturing a bridge for a set of teeth, wherein the bridge comprises at least two crowns placed fixedly therein, wherein the device comprises means for arranging cavities in the bridge for receiving in the cavities in at least practically fitting manner mounting bases provided in a jaw, and wherein the device comprises a control code for controlling the device, characterized in that the control code enables the means for arranging cavities in the bridge to arrange at least two of the cavities as cavities which are undercut in a direction transversely of a longitudinal direction of the bridge.

15. Device as claimed in claim 14, characterized in that the device is provided with input means for receiving one or more data from a group comprising a shape of a bridge to be manufactured, dimensions of a bridge to be manufactured, a shape of cavities to be arranged, dimensions of cavities to be arranged.

16. Device as claimed in claim 14, characterized in that the means for arranging cavities in the bridge comprise a cutter.
